(19) United States
(12) Patent Application Publication
(10) Pub. No.: US 2015/0317321 A1
(43) Pub. Date: Nov. 5, 2015

(54) NETWORK INFORMATION DISPLAY METHOD, SYSTEM AND TERMINAL, AND INFORMATION DISPLAY PROCESSING DEVICE

(71) Applicant: TENCENT TECHNOLOGY (SHENZHEN) COMPANY LIMITED, Shenzhen, Guangdong (CN)

(72) Inventors: Yuanhai Tang, Shenzhen Guangdong (CN); Bin Zhou, Shenzhen Guangdong (CN)

(73) Assignee: TENCENT TECHNOLOGY (SHENZHEN) COMPANY LIMITED, Shenzhen Guangdong (CN)

(21) Appl. No.: 14/648,492

(22) PCT Filed: Sep. 22, 2013
(86) PCT No.: PCT/CN2013/083926

§ 371 Date: May 29, 2015

(30) Foreign Application Priority Data
Dec. 3, 2012 (CN) 201210507840.8

(51) Int. Cl. G06F 17/30; H04L 29/08; G06F 3/0484; G06F 3/0482

(52) U.S. Cl. CPC G06F 17/3089; G06F 3/0482; H04L 67/26; G06F 17/30864; G06F 3/04842

(57) ABSTRACT

A system to display network information is provided. The system may acquire a selected content on a web page, and search a website material database according to the selected content to obtain material matching the selected content. The system may send the matching material to a terminal, which may display the matching information at a specific area in a website right-click menu of the terminal. The system may record the selected content on the web page and send the selected content upon a right-click instruction When the material matching the selected content is received, the matching material may be displayed at the specific area in the website right-click menu.

### FIELD OF THE TECHNOLOGY

The present disclosure relates to the field of information transmission technologies, and in particular, to a method and system for displaying network information, a terminal, and an apparatus for processing information display in a network.

### BACKGROUND OF THE DISCLOSURE

With mature development of Internet technologies, the amount of information transmitted over a network has increased tremendously. Information transmitted over a network includes sound, video, image, and text information. Interaction information may also be delivered by combining vision, hearing, and interactive vision. However, limited by space of a website page, and the limited amount of bandwidth available via network information carriers, the requirements of transmitting an increasing amount of information to be transmitted is not satisfied, thus causing a technical bottleneck. Thus there is an urgent need to solve the technical problems related to developing a form of transmission and display of network information, to transmit and display more network information using a limited bandwidth, and to increase information provided by a website.

### SUMMARY

The present document provides a method and system for displaying network information, a terminal, and an apparatus for processing information display to develop a form of transmission and display of network information, transmit and display more network information, and increase an information provided by a website.

In one general aspect a method for displaying network information, may include acquiring selected content on a website page, and searching a website material database according to the selected content to obtain material matching the selected content. The method also includes pushing the obtained material to a terminal, and displaying, on the terminal, the obtained material at a predetermined area of a right click menu of a website.

In another general aspect a method for displaying network information, may include collecting content selected from a website page, and sending the selected content after acquiring a right click instruction. The method also includes in response to receiving material matching the selected content, displaying the material in a predetermined area of a right click menu of the website page.

In one general aspect an apparatus for processing information display, may include a matching module configured to acquire selected content on a website page and search a website material database according to the selected content to obtain material matching the selected content. The apparatus also includes a pushing module configured to push the obtained material to a terminal and display, on the terminal, the obtained material in a specific area of a right click menu of a website.

In another general aspect a terminal may include a collecting and sending module configured to collect content selected from a website page and send the selected content in response to a right click instruction. The terminal also includes a display module configured to, in response to material matching the selected content being received, display the received material in a specific area of a right click menu of a website.

Another aspect provides a system for displaying network information, including: the apparatus for processing information display of the present disclosure, and the terminal of the present disclosure.

Yet another aspect further provides a computer storage medium, having a computer executable instruction stored therein, where the computer executable instruction is configured to execute the method for displaying information.

In the method and system for displaying network information, the terminal, and the apparatus for processing information display provided by the present document, a right click menu is expanded to serve as a material display area. The material displayed in response to the right click occupies a smaller area on a website page. Thus, the material displayed on the menu saves space that otherwise may be taken up on the website page. Accordingly, a form of transmission and display of network information is developed, and more network information may be transmitted and displayed, thus, increasing an information capacity of a website.

### BRIEF DESCRIPTION OF THE DRAWINGS

FIG. 1 is flowchart 1 of a method for displaying network information according to an example;

FIG. 2 is flowchart 2 of a method for displaying network information according to an example;

FIG. 3 is a schematic structural diagram of an apparatus for processing information display according to an example;

FIG. 4 is a schematic structural diagram of a terminal according to an example; and

FIG. 5 is a schematic diagram of displaying material according to a selected text on a website page in an example.

### DESCRIPTION OF EMBODIMENTS

The technical solution of the present disclosure is described in further detail with reference to the accompanying drawings and specific embodiments in the following.

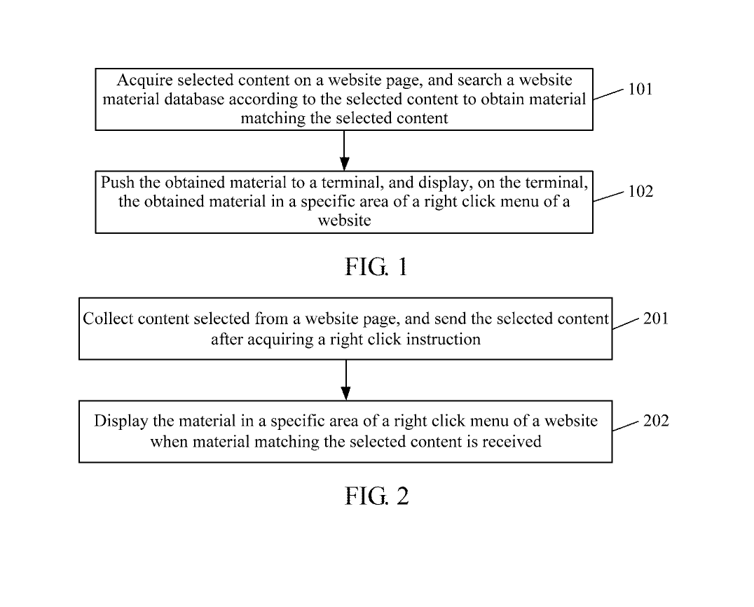

As shown in FIG. 1, an example method for displaying network information executed by a website background server includes at least the following steps.

Step 101 may include acquiring selected content on a website page, and search a website material database according to the selected content to obtain material matching the selected content.

The selected content on the website page may include a text and/or a picture.

The material refers to different kinds of information such as a text, a picture, video, and audio.

The website material database is established in advance, and each piece of material is indexed using a corresponding keyword. The material may be mapped with corresponding keywords. Once the content matches a keyword, the corresponding material may be invoked. For example, the material may be classified based on the keywords. The keywords may be used for subsequent material matching and precise directing. The website material database may be stored by a website background server, or stored by a dedicated data storing server, where the data storing server may be invoked by the website background server.

For example, if the selected content is a text, steps such as those described in code below may be executed for acquiring the selected text on the website page,

function getSelText( ){

var txt = “;
if (window.getSelection) {

txt = window.getSelection( );

} else if (document.getSelection) {

txt = document.getSelection( );

} else if (document.selection) {

txt = document.selection.createRange( ).text;

} else {

return;

}

}

Further, a website material database may be searched according to the selected text to obtain material matching the selected text. For example, instructions to perform a search may be as follows:

function request_lview(lview_url,load_area_id){

var callback = function( ) {

clearTimeout(timeout_handle);
renderBuffer.apply(window, load_area_id);
each(load_area_id, function(area_id) {

delete in_reqeusting_ids[area_id];
});

};
importScript(lview_url, callback, crystal_args.charset) ;
rot = “;

| | |
|---|---|
| var | timeout_handle=setTimeout(callback, |

crystal_args.lview_time_out*1000);

}
var importScript = function(url, callback, charset) {

var script = document.createElement(‘script’);
script.src = url;
if (charset) {

script.charset = charset;

}
if (callback) {

if (ua.ie) {

script.onreadystatechange = function( ) {

var rs = this.readyState;

if (“loaded” === rs || “complete” === rs) {

callback( );

}

};

} else {

script.onload = callback;

}

}
document.getElementsByTagName(‘head’)[0].appendChild(script);

};

If the selected content on the website page is a text, after the selected text on the website page is acquired, word segmentation processing may be performed on the selected text. The word segmentation may identify at least one morpheme (namely, a smallest unit during the word segmentation processing on the text). The identified morpheme may be matched with the keywords in the material database. A keyword may be determined that has the highest matching degree with the identified morpheme. At least one piece of material corresponding to the keyword having the highest matching degree may be selected from the material database.

In another example, the selected content on the website page may be a picture. The selected picture on the website page may be acquired. The selected picture may be scanned and analyzed. At least one piece of material (a picture or a text) from the website material database may be extracted according to the scanning and analyzing. The material extracted may have the highest matching degree with the result of the scanning and analyzing.

Alternatively or in addition, in case a picture is selected, a text corresponding to the selected picture (for example, a descriptive text which is on the website page and about the picture or a title text of the picture) may be extracted from the website page. The word segmentation may be performed on the extracted text to obtain a morpheme. The morpheme may be matched with the keywords in the material database to determine a keyword with highest degree of matching. The material, from the material database, corresponding to the keyword having the highest matching degree with the morpheme is selected.

In different examples, precise matching or fuzzy matching may be used for material matching, which may be a setting that may be adjusted. For example, when a material above a predetermined threshold may be matched, precise matching may be selected. Instead, if the amount of material that may match with the selection is below a predetermined threshold, the fuzzy matching may be selected. The precise matching refers to that all keywords corresponding to the material are contained in the morphemes that are obtained after the word segmentation is performed on the selected text on the page. The fuzzy matching refers to that some of the keywords corresponding to the material are contained in the morphemes that are obtained after the word segmentation is performed on the selected text on the page.

In Step 102 the obtained material may be pushed to a terminal. The terminal may display the obtained material in a specific area of a right click menu of a website.

In an example, an application programming interface of the website may be invoked to modify website space. A specific area in the right click menu of the website may be created. The specific area may be a display area occupying at least one content item in the right click menu of the website, or a background area of the right click menu of the website.

After selection of content on the website page by a user via a terminal, the website background server may push the obtained material to the terminal in response to a right mouse button click, so that the obtained material is displayed in the specific area of the right click menu of the website.

For example, if the selected content is a text, the obtained material may be pushed to the specific area of the right click menu for display according to steps described in the following code.

function Click(obj){

obj.onmousedown=new_menu;
document.getElementById(‘h’).innerHTML=obj.id;

}
function new_menu(e){

addEventHandler(document, “mousedown, document_MouseDown);
var e=e∥window.event;
var value = e.button;
var createDiv=document.getElementById(‘createDiv’);
if(value==2){

createDiv.style.display=‘block’;
createDiv.style.left=e.clientX+‘px’;
createDiv.style.top=e.clientY+‘px’;
createDiv.innerHTML=document.getElementById(‘h’).innerHTM

L;

document.oncontextmenu=function( ){

return false;

}
return false;

}else{

createDiv.style.display=“none”;

}

}

The terminal may be instructed to display a default right click menu of the website in case the material matching the selected content is not obtained by searching the website material database.

In an example, the application programming interface of the website may be invoked to further create, in the right click menu of the website, an invocation interface for a third-party platform of the user. For example, an interface may be embedded in the right click menu to prompt the user to share the displayed content to the third-party platform of the user (such as a blog or a microblog, such as WEIBO™ or TWITTER™ of the user). Thus, upon receiving a terminal instruction, the website background server may send the material displayed in the specific area of the right click menu of the website to the third-party platform of the user. Thus, the material may be shared via the third party platform, or account of the user.

As shown in FIG. 2, in an example method for displaying network information executed by a terminal, the method may include at least the following steps.

In step 201 the terminal may collect content selected from a website page, and send the selected content in response to a right click instruction at the terminal.

The selected content on the website page may include at least one of a text and a picture.

After a user selects content on the website page, the terminal may send the selected content to a background server in response to a right mouse button click. The background server may use the selected content for material matching.

In step 202, the terminal may display, material matching the selected content in a specific area of a right click menu of a website. The matching material may be received by the terminal from the background server and the step 202 may be invoked in response to receipt of the matching material.

When the material that matches the selected content provided by the background server is received, the material may be displayed in the specific area of the right click menu of the website.

When the material that matches the selected content that may be provided by the background server is not received, a default right click menu of the website is displayed. The background server may notify the terminal that no matching material was found.

In another example, if a third-party sharing instruction initiated by the user is acquired, the background server may be instructed to send the material displayed in the specific area of the right click menu to the third-party platform. The user may provide the instruction to share the material via the website page.

The right click menu of the website may be closed in response to an instruction of closing the right click menu of the website (for example, a mouse of the user clicks on an area outside the right click menu of the website). In an example, the steps to close the menu may be according to the example code below.

function document_MouseDown(e) {

var element = typeof event != “undefined” ? event.srcElement :

e.target;

var downPanel = false;
while (element) {

| | | | |
|---|---|---|---|
| downPanel | = | element | = |

document.getElementById(document.getElementById(‘h’).innerHTML);

if (downPanel) break;
element = element.parentNode;

}
if (!downPanel) {

removeEventHandler(document,“mousedown”,document_MouseDown);

document.getElementById(‘createDiv’).style.display = “none”;
document.oncontextmenu=function( ){

return true;

}

}

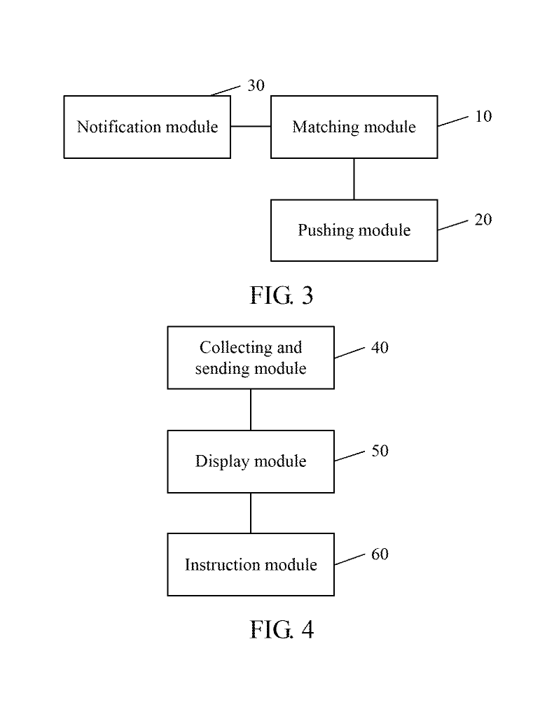

FIG. 3 illustrates an apparatus for processing information display. The apparatus may include a matching module 10 and a pushing module 20.

The matching module 10 may acquire selected content on a website page, and search a website material database according to the selected content to obtain material matching the selected content.

The pushing module 20 may push the obtained material to a terminal, and cause the terminal to display, on the terminal, the obtained material in a specific area of a right click menu of a website.

The material database may store a mapping between material and keywords.

Accordingly, the matching module 10, in response to the selected content on the website page being a text, may perform word segmentation on the selected text. The word segmentation may identify a morpheme. The matching module 10 may match the identified morpheme with the keywords in the material database. The matching module 10 may select, from the material database, at least one piece of material corresponding to a keyword having a highest matching degree with the morpheme.

In another example, the selected content on the website page may be a picture. The matching module 10 may scan and analyze the selected picture, and extract at least one piece of material having a highest matching degree from the website material database according to a scanning and analyzing result. Alternatively or in addition, the matching module 10 may extract, from the website page, a text corresponding to the selected picture. The matching module 10 may perform word segmentation on the extracted text to obtain at least one morpheme. The matching module 10 may perform matching on the obtained morpheme with the keywords in the material database, and select, from the material database, at least one piece of material corresponding to a keyword having a highest matching degree with the morpheme.

The apparatus may further include a notification module 30 that instructs the terminal to display a default right click menu of the website when the material matching the selected content is not obtained by searching the website material database.

The pushing module 20 may send the material displayed in the specific area of the right click menu to a third-party platform of a terminal user. The pushing module 20 may send the material displayed in response to an instruction of the terminal.

The matching module 10 may be implemented by a central processing unit (CPU), a micro processing unit (MPU), a digital signal processor (DSP), or the like of the apparatus for processing information display. The pushing module 20 and the notification module 30 may be implemented by a chip having a communication function in the apparatus for processing information display.

FIG. 4 illustrates a terminal, which may include a collecting and sending module 40 and a display module 50.

The collecting and sending module 40 may collect content selected from a website page, and send the selected content in response to a right click instruction at the terminal.

The display module 50 may display the material in a specific area of a right click menu of a website when material matching the selected content is received.

The display module 50 may display a default right click menu of the website when the material matching the selected content is not received.

The terminal may further include an instruction module 60 that may instruct a background server to send the material displayed in the specific area of the right click menu to a third-party platform. The material may be sent to an account of the user with the third-party platform. The material may be sent to the third-party platform in response to an instruction of the user acquired from the website page.

The collecting and sending module 40 and the instruction module 60 may be implemented by a chip having a communication function in the terminal, and the display module 50 may be implemented by a CPU, an MPU, a DSP, or the like in the terminal.

In an example, a system for displaying network information may include the apparatus for processing information display as shown in the FIG. 3 and the terminal as shown in FIG. 4.

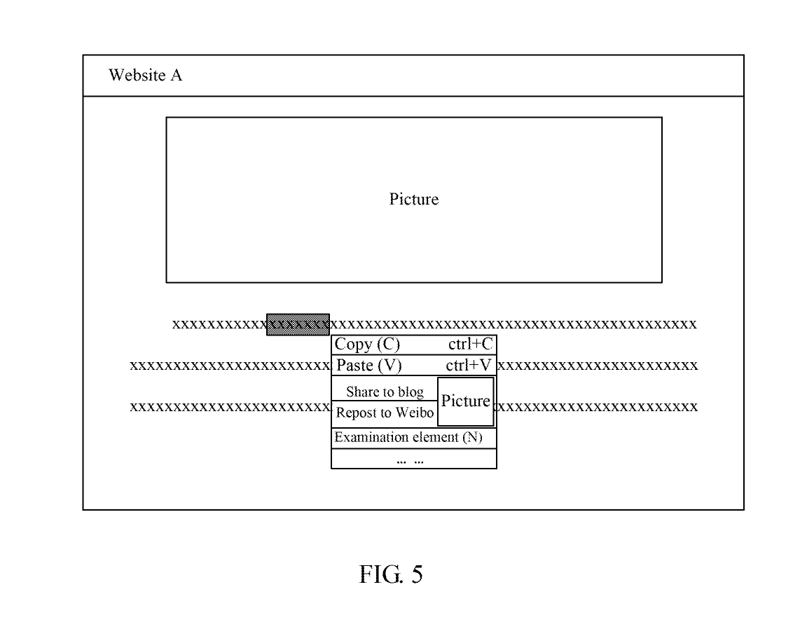

The method and system for displaying information are described in further detail by using an example in which material is displayed according to a selected text on a website page and with reference to the schematic diagram shown in FIG. 5.

Consider a user is viewing a page of a website A on a terminal. The user may draft a mouse, or other pointing device to select a text on the web page (shown as a shadow region in FIG. 5). Upon a right mouse button click, the terminal may send the selected text to a background server of the website A. The background server of the website A may search a website material database according to the text sent by the terminal to obtain material matching the selected text (matched material in FIG. 5 is a picture). The background server may push the obtained material to the terminal, and instruct the terminal to display the material in a specific, predetermined, or designated area of a right click menu. The terminal may display the material in the specific area (which is planned in advance) of the right click menu of the website A after the terminal receives the notification of the background server. Subsequently, in response to an instruction, such as a user click, to share the material, such as a “share to blog” option or “repost to Weibo” option in the right click menu, the terminal may instruct the background server to send the material displayed in the specific area of the right click menu via the network. For example, the material may be sent to the blog or WEIBO™ of the user. The background server may send the material displayed in the specific area of the right click menu to the blog or WEIBO™ account of the user according to the instruction of the terminal. In response to a click on an area outside the right click menu, the terminal may close the right click menu, and no longer displays the right click menu.

Thus, the right click menu may be expanded to serve as a material display area, so that material occupies a smaller area on the website page. Thus, space of the website page may be saved. Accordingly, a form of transmission and display of network information is developed, and more network information can be transmitted and displayed. Accordingly, an information capacity of a website may be increased. The material displayed in the right click menu can be sent to the blog or WEIBO™ or other account of the user by using an interface on the right click menu, which implements widespread propagation of the material.

If the integrated modules described in the examples described throughout the present document are implemented in a form of a software functional module and sold or used as an independent product, the method may be stored in a computer readable storage medium. Based on such an understanding, the technical solutions of the present document, or the part contributing to the existing technology may be shown in a form of a software product. The computer software product may be stored in a storage medium and may include several instructions for instructing a computer device (which may be a personal computer, a server, a network device, or the like) to execute all or some of the methods described throughout the present document. The foregoing storage medium may be any medium that can store program code, such as a USB flash drive, a removable hard disk, a read-only memory (ROM), a random access memory (RAM), a magnetic disk, or an optical disc. In this way, the embodiments of the present invention are not limited to any particular combination of hardware and software.

Accordingly, an aspect of the present document provides a computer storage medium, having a computer program stored therein, where the computer program is configured to execute the method for displaying information according to the examples described throughout the present document.

The system may be implemented in many different ways. Each component, such as the matching module 10, the pushing module 20, the collecting and sending module 40, and the display module 50, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each component may include memory hardware, such as a portion of a memory, for example, that comprises instructions executable with a processor to implement one or more of the features of the module. When any one of the module includes the portion of the memory that comprises instructions executable with the processor, the module may or may not include the processor. In some examples, each component may just be the portion of the memory or other physical memory that comprises instructions executable with the processor to implement the features of the corresponding component without the module including any other hardware. Because each module includes at least some hardware even when the included hardware comprises software, each module may be interchangeably referred to as a hardware component, such as the matching hardware, the pushing hardware, the collecting and sending hardware, and the display hardware.

Although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for displaying network information, comprising:
acquiring selected content on a website page, and searching a website material database according to the selected content to obtain material matching the selected content; and
pushing the obtained material to a terminal, and displaying, on the terminal, the obtained material at a predetermined area of a right click menu of a website.

2. The method for displaying network information according to claim 1, wherein the material database stores a mapping between material and keywords, and
in response to the selected content on the website page being text, searching the website material database according to the selected content to obtain material matching the selected content comprises:
performing word segmentation processing on the selected text to obtain at least one morpheme, performing matching on the obtained morpheme with the keywords in the material database, and selecting, from the material database, at least one piece of material corresponding to a keyword having the highest matching degree with the morpheme; and
in response to the selected content on the website page being a picture, searching the website material database according to the selected content to obtain material matching the selected content comprises:
scanning and analyzing the selected picture, and extracting at least one piece of material having a highest matching degree from the website material database based on the scanning and analyzing; or
extracting, from the website page, a text corresponding to the selected picture, performing word segmentation processing on the extracted text to obtain at least one morpheme, performing matching on the obtained morpheme with the keywords in the material database, and selecting, from the material database, at least one piece of material corresponding to a keyword having the highest matching degree with the morpheme.

3. The method for displaying network information according to claim 1, further comprising:
instructing the terminal to display a default right click menu of the website when the material matching the selected content is not obtained by searching the website material database.

4. The method for displaying network information according to claim 1, further comprising:
sending the material displayed at the predetermined area of the right click menu to a third-party platform of a terminal user according to an instruction of the terminal.

5. A method for displaying network information, comprising:
collecting content selected from a website page, and sending the selected content after acquiring a right click instruction; and
in response to receiving material matching the selected content, displaying the material in a predetermined area of a right click menu of the website page.

6. The method for displaying network information according to claim 5, further comprising:
displaying a default right click menu of the website page in response to the material matching the selected content not being received.

7. The method for displaying network information according to claim 5, further comprising:
instructing a background server to send the material displayed in the sp predetermined area of the right click menu to a third-party platform of a user according to an instruction of the user acquired from the website page.

8. An apparatus for processing information display, comprising:
a matching module configured to acquire selected content on a website page and search a website material database according to the selected content to obtain material matching the selected content; and
a pushing module configured to push the obtained material to a terminal and display, on the terminal, the obtained material in a specific area of a right click menu of a website.

9. The apparatus for processing information display according to claim 8, wherein the material database stores a mapping between material and keywords;
accordingly, the matching module is further configured to: in response to the selected content on the website page being a text, perform word segmentation on the selected text to identify at least one morpheme, match the identified at least one morpheme with the keywords in the material database, and select, from the material database, at least one piece of material corresponding to a keyword with a highest matching degree with the morpheme; and
in response to the selected content on the website page being a picture, scan and analyze the selected picture, and extract, from the website material database, at least one piece of material having a highest matching degree; or extract, from the website page, a text corresponding to the selected picture, perform word segmentation on the extracted text to identify at least one morpheme, match the identified at least one morpheme with the keywords in the material database, and select, from the material database, at least one piece of material corresponding to a keyword with a highest matching degree with the morpheme.

10. The apparatus for processing information display according to claim 8, further comprising: a notification module, further configured to instruct the terminal to display a default right click menu of the website when the material matching the selected content is not obtained by searching the website material database.

11. The apparatus for processing information display according to claim 8, wherein the pushing module is further configured to send the material displayed in the specific area of the right click menu to a third-party platform of a terminal user according to an instruction of the terminal.

12. A terminal, comprising:
a collecting and sending module configured to collect content selected from a website page and send the selected content in response to a right click instruction; and
a display module configured to, in response to material matching the selected content being received, display the received material in a specific area of a right click menu of a website.

13. The terminal according to claim 12, wherein the display module is further configured to display a default right click menu of the website in response to the material matching the selected content not being received.

14. The terminal according to claim 12, further comprising: an instruction module configured to instruct a background server to send the material displayed in the specific area of the right click menu to a third-party platform of a user according to an instruction of the user acquired from the website page.

15-17. (canceled)

18. The method for displaying network information according to claim 2, further comprising:
instructing the terminal to display a default right click menu of the website when the material matching the selected content is not obtained by searching the website material database.

19. The method for displaying network information according to claim 2, further comprising:
sending the material displayed at the predetermined area of the right click menu to a third-party platform of a terminal user according to an instruction of the terminal.

20. The method for displaying network information according to claim 6, further comprising:
instructing a background server to send the material displayed in the predetermined area of the right click menu to a third-party platform of a user according to an instruction of the user acquired from the website page.

21. The apparatus for processing information display according to claim 9, further comprising: a notification module, further configured to instruct the terminal to display a default right click menu of the website when the material matching the selected content is not obtained by searching the website material database.

22. The apparatus for processing information display according to claim 9, wherein the pushing module is further configured to send the material displayed in the specific area of the right click menu to a third-party platform of a terminal user according to an instruction of the terminal.

23. The terminal according to claim 13, further comprising: an instruction module configured to instruct a background server to send the material displayed in the specific area of the right click menu to a third-party platform of a user according to an instruction of the user acquired from the website page.
